(19) United States
(12) Patent Application Publication
(10) Pub. No.: US 2018/0083555 A1
(43) Pub. Date: Mar. 22, 2018

(54) Field Winding Type Synchronous Motor and Control Method Thereof

(71) Applicant: Hitachi, Ltd., Tokyo (JP)

(72) Inventors: Daisuke KORI, Tokyo (JP); Takayuki KOYAMA, Tokyo (JP); Motonobu IIDUKA, Tokyo (JP)

(21) Appl. No.: 15/661,253

(22) Filed: Jul. 27, 2017

(30) Foreign Application Priority Data
Sep. 21, 2016 (JP) 2016-184468
Sep. 27, 2016 (JP) 2016-187838

(51) Int. Cl. H02P 1/50

(52) U.S. Cl. CPC H02P 1/50

(57) ABSTRACT

A field winding type synchronous motor includes an exciter 4 and, after starting by forming a short circuit of a field winding 10, excites the field winding by using the exciter, and includes a starting control circuit 30 that outputs a control signal controlling On/Off of a first opening/closing device, in which the exciter and the field winding are connected through the first opening/closing device 1. The starting control circuit includes: a signal transmitting circuit that outputs the control signal at timing, which is detected based on an induced electromotive voltage generated in the field winding, at which switching to a synchronous operation is performed; and a time limit setting circuit that, after a predetermined time elapses after the starting control circuit is started, directs the signal transmitting circuit to output the control signal.

### TECHNICAL FIELD

The present invention relates to a field winding type synchronous motor and a control method for starting a field winding type synchronous motor.

### BACKGROUND ART

As a starting unit of a field winding type synchronous motor, a unit using an inverter is applied. However, in a case where a variable-speed operation is not necessary, the inverter is used only at the time of starting, and accordingly, the burden of an initial cost, an installation space, and the like corresponding to the inverter is large.

In contrast to this, a direct online (DOL) starting unit is a starting unit that does not use an inverter. This starting unit is a starting unit similar to an all-voltage starting unit of an induction motor and starts a synchronous motor by using the characteristics of an induction motor. At this time, in order to acquire the characteristics of an induction motor, a field winding disposed on the rotor side is separated from an AC exciter for excitation to be in a short-circuit state. In addition, in order to suppress a decrease in starting torque, a discharge resistor (DR) is inserted into a short circuit.

However, the DR generates a power loss at the time of a steady operation at a synchronization speed, and accordingly, the efficiency of a motor is decreased. For this reason, it is necessary to separate the DR at the time of a synchronous operation. In order to proceed from the DOL starting to a synchronous operation, when the motor is accelerated up to near a synchronous speed after the starting, the field winding is switched from the short-circuit state to a state being connected to the AC exciter. As a conversion unit, a thyristor is disposed between a rectification circuit and the field winding. The thyristor is opened or closed by a dedicated starting control circuit. The starting control circuit detects the slip (frequency) and the amplitude of an induced electromotive voltage generated in the field winding and outputs a control signal to the thyristor in accordance with a detected signal.

At the time of conversion into a state in which the field winding is connected to the AC exciter, in other words, at the time of performing field input, a proper phase is necessary. A condition of the proper phase is changed according to the influence of the characteristics, the load, the inertia, and the like of a synchronous motor at the time of starting. Accordingly, in a case where field input cannot be performed with a proper phase, there is concern that an armature current, torque, rotation speed after the field input become unstable. An induced electromotive voltage is an input signal for the starting control circuit. Since the starting control circuit outputs a control signal based on the input signal, in a case where the input signal becomes undetectable due to a defect, a rapid change (a loss before the signal arrives at a set value) of the signal, or the like, a control signal cannot be output from the starting control circuit to the thyristor. For this reason, there is concern that it is difficult to switch to a field voltage supplied from the AC exciter.

Regarding a circuit used for switching from the starting of a field winding type synchronous motor to a synchronous operation, technologies described in JP 2015-33150 A, JP 7-59372 A, JP 3-78478 A, and JP 6-343250 A are known.

### SUMMARY OF THE INVENTION

### Problems to be Solved by the Invention

The present invention provides a field winding type synchronous motor having high reliability of field input and a control method thereof.

### Solutions to Problems

In order to achieve the objects described above, for example, motors described in the claims are provided.

### Effects of the Invention

According to the present invention, the reliability of the field input can be improved.

Objects, configurations, and effects other than those described above become apparent by referring to the description of the following embodiments.

### BRIEF DESCRIPTION OF THE DRAWINGS

FIG. 1 is an external view of a field winding type synchronous motor according to Embodiment 1 of the present invention;

FIG. 2 is a cross-sectional view of a rotor and a stator according to Embodiment 1;

FIG. 3 illustrates the circuit configuration of a synchronous input device according to Embodiment 1;

FIG. 4 illustrates an example of the waveform of an induced electromotive voltage that is an input signal of a starting control circuit;

FIG. 5 illustrates a functional block diagram of a starting control circuit;

FIG. 6 illustrates an example of the waveforms of a voltage generated in a field winding and a signal output from a starting control circuit;

FIG. 7 illustrates an example of the waveforms of a voltage generated in a field winding and a signal output from a starting control circuit;

FIG. 8 illustrates an example of the waveforms of a voltage generated in a field winding and a signal output from a starting control circuit in a case where an abnormality occurs in an induced electromotive voltage;

FIG. 9 illustrates another example of the waveforms of a voltage generated in a field winding and a signal output from a starting control circuit in a case where an abnormality occurs in an induced electromotive voltage;

FIG. 10 illustrates an example of the waveforms of a voltage generated in a field winding and a signal output from a starting control circuit in a case where a time limit setting circuit operates;

FIG. 11 illustrates the circuit configuration of a synchronous input device in a field winding type synchronous motor according to Embodiment 2 of the present invention;

FIG. 12 illustrates the circuit configuration of a synchronous input device in a field winding type synchronous motor according to Embodiment 3 of the present invention;

FIG. 13 illustrates the waveform of a DC voltage output by a rectification circuit;

FIG. 14 illustrates the circuit configuration of a synchronous input device in a field winding type synchronous motor according to Embodiment 4 of the present invention;

FIG. 15 illustrates the internal configuration of a temperature detecting circuit;

FIG. 16 illustrates the circuit configuration of a synchronous input device in a field winding type synchronous motor according to Embodiment 5 of the present invention;

FIG. 17 illustrates the circuit configuration of a synchronous input device in a field winding type synchronous motor according to Embodiment 6 of the present invention;

FIG. 18 illustrates the internal configuration of a current detecting circuit;

FIG. 19 illustrates an example of the waveforms of a voltage generated in a field winding and a signal output from a starting control circuit in a field winding type synchronous motor according to Embodiment 7 of the present invention;

FIG. 20 illustrates the circuit configuration of a field winding type synchronous motor according to Embodiment 8 of the present invention; and

FIG. 21 is an external view of a field winding type synchronous motor according to Embodiment 9 of the present invention.

### MODE FOR CARRYING OUT THE INVENTION

Hereinafter, embodiments of the present invention will be described with reference to the drawings by using the following Embodiments 1 to 9. In the drawings, constituent elements having a same reference numeral represent a same constituent element or constituent elements having functions similar to each other.

### Embodiment 1

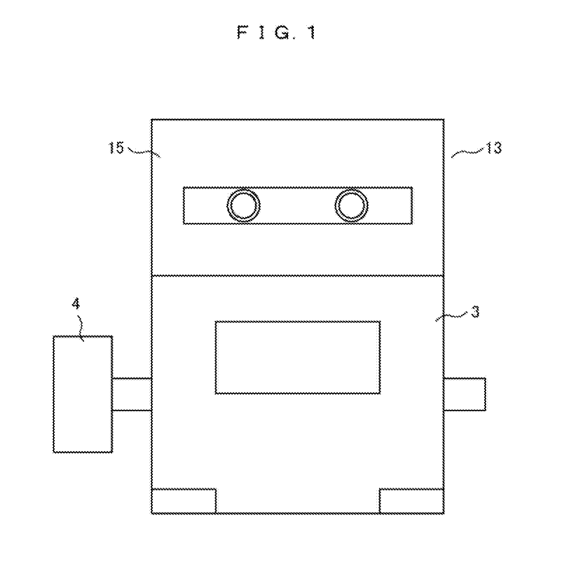

FIG. 1 is an external view of a field winding type synchronous motor according to Embodiment 1 of the present invention. This Embodiment 1 is applied to an LNG plant of the class of several tens of MW, is supplied with a three-phase AC power source as a drive power source, and rotates at a rotation speed in the range of 750 to 1800 min⁻¹.

As illustrated in FIG. 1, the field winding type synchronous motor 13 includes: a rotator unit 3; a heat exchanger 15 used for cooling the rotator unit 3; and an AC exciter 4 (in this embodiment, a brushless AC exciter) for excitation. Inside the casing of the rotator unit 3, a rotor, a stator, and a shaft to be described later are arranged. While not illustrated in the drawing, a fan used for circulating cooling air inside the rotator unit 3 is arranged. The AC exciter 4 is a device used for excitation by causing a DC current to flow through a field winding of the rotator. The heat exchanger 15 is a device used for heat exchange of cooling air inside the rotator unit 3. While the heat exchanger 15 is a heat exchanger of a water-cooling type in this embodiment, a heat exchanger of an air-cooling type may be used.

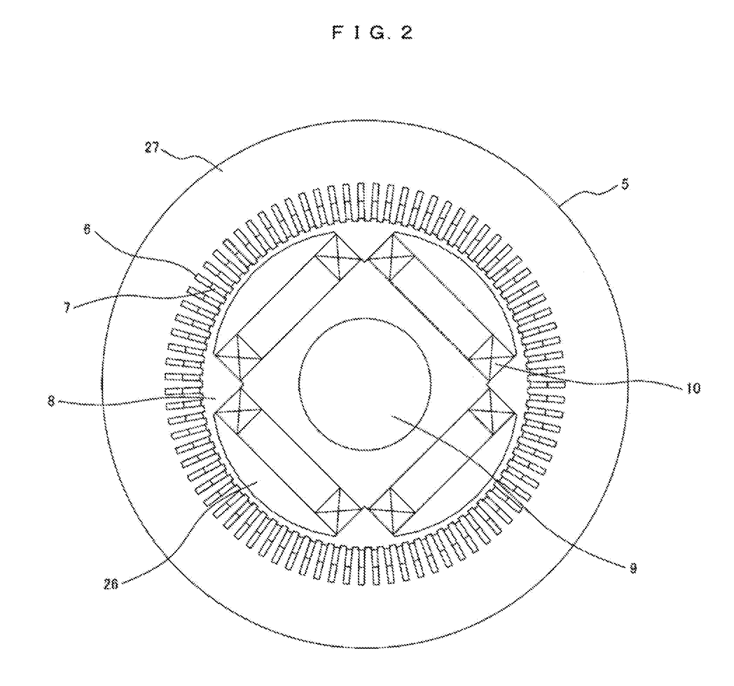

FIG. 2 is a cross-sectional view of the rotor and the stator according to Embodiment 1.

As illustrated in FIG. 2, the rotor 8 includes: a rotor core 26; a shaft 9 that is a rotation shaft; and a field winding 10 that is wound around the rotor core 26. The field winding 10 is arranged to have the winding direction changed such that the polarity is alternately changed in the circumferential direction. In order to acquire a damper effect, the rotor core 26 is configured as a lump-shaped core. Accordingly, the torque at the time of starting can be increased. In addition, as the rotor core 26, a laminated electromagnetic steel sheet may be used. In the stator 5, a stator core 27 is configured by stacking electromagnetic steel sheets in the axial direction, and a coil 7 is arranged in a stator slot 6.

As illustrated in FIG. 2, in Embodiment 1, while the number of rotor poles is four, and the number of stator slots is 84, the number of the rotor poles and the number of stator slots may be different values. In addition, the method of winding the coil 7 may be either distributed winding or concentrated winding.

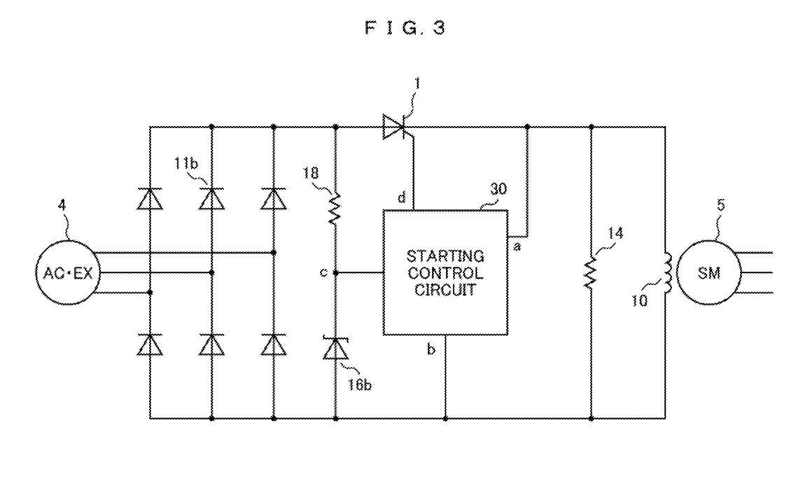

FIG. 3 illustrates the circuit configuration of a synchronous input device according to Embodiment 1. Hereinafter, the circuit operation will be described with reference to FIG. 3.

At the time of starting, the thyristor 1 is in an Off state. Thus, while the field winding 10 is electrically disconnected from an excitation circuit including the AC exciter 4, a discharge resistor (DR) 14 is connected in parallel with the field winding 10. In other words, both ends of the field winding 10 form a short circuit through the DR 14. Accordingly, at the time of starting, by applying a three-phase voltage to the stator 5, an induced electromotive current is generated in the field winding 10, and starting can be performed based on a same operation principle as that of an induction motor. By arranging the DR 14, similar to the adjustment of starting torque using a resistor of a secondary circuit in the induction motor, a decrease in the starting torque can be suppressed.

Here, instead of the thyristor 1, an opening/closing circuit such as an insulated gate bipolar transistor (IGBT) or a gate turn off (GTO) thyristor may be used.

In this Embodiment 1, the discharge resistor is configured using fixed resistance.

Next, when the field winding type synchronous motor is accelerated up to near a synchronization speed, the synchronous input device performs a field input operation so as to switch the operation of the field winding type synchronous motor to a synchronous operation. Here, the power generation principle of the AC exciter 4 is similar to that of a so-called AC excitation type synchronous generator, and, by causing an excitation current to flow to the stator side of the AC exciter 4 and rotating the rotor of the AC exciter 4 around a same axis as that of the rotor 8 of the rotator unit 3, a power generation current is generated in the rotor of the AC exciter 4. In this way, an excitation current can be supplied to the field winding 10 in a brushless manner. According to such an operation, the power generation current increases according to the acceleration of the motor. A three-phase AC current flowing from the AC exciter 4 is converted into a DC current by a three-phase type rectification circuit configured by six diodes 11b.

At the time of starting, the thyristor 1 is in the Off state, and accordingly, a DC current does not flow to the field winding 10. When a control signal, in other words, a gate driving current is transmitted from the starting control circuit 30 to the gate of the thyristor 1, the thyristor 1 is turned on, whereby a DC current flows to the field winding 10.

Regarding a condition for turning on the thyristor 1, it is preferable to detect a strong point of starting characteristics and turning on the thyristor 1 near the synchronization speed. For this reason, in a starting control circuit 30, an induced electromotive voltage at the time of starting is acquired from the cathode side of the thyristor 1 as an input signal.

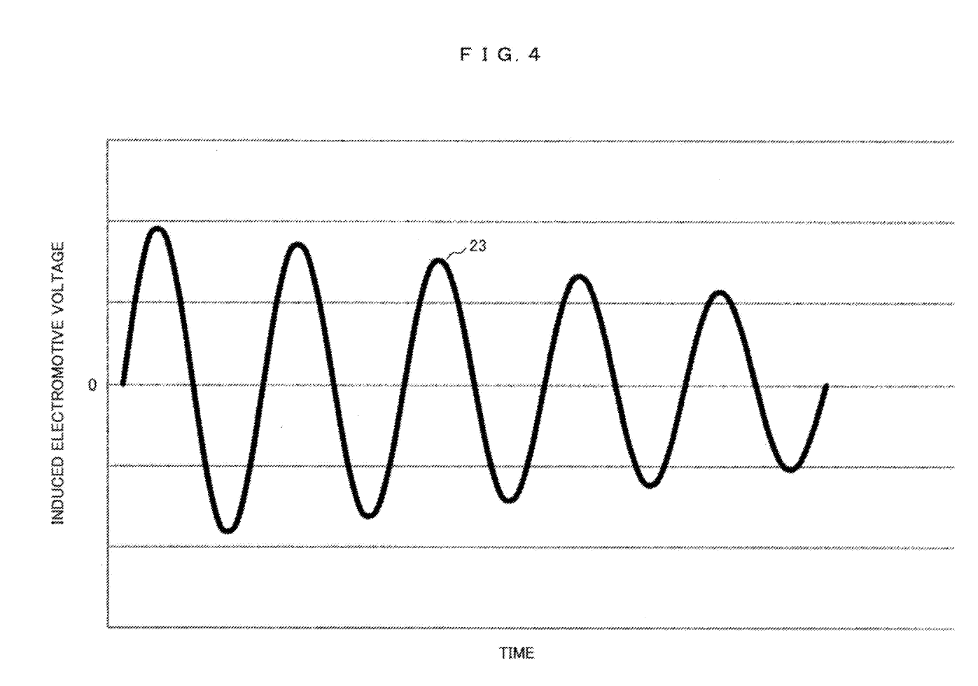

FIG. 4 illustrates an example of the waveform of an induced electromotive voltage that is the input signal of the starting control circuit 30.

As illustrated in FIG. 4, at the time of starting, the amplitude of the voltage is large, and the frequency is high. This is similar to a state in which the slip of the induction motor is large, and, as acceleration is made toward the synchronization speed (rated speed), both the amplitude and the frequency of the induced electromotive voltage 23 are attenuated. Thus, when it is detected that the amplitude or the frequency of the induced electromotive voltage 23 is decreased to be a predetermined value, which is set in advance, or less, the rotation speed is near the synchronization speed, and it can be detected that it is timing for performing switching to the synchronization operation.

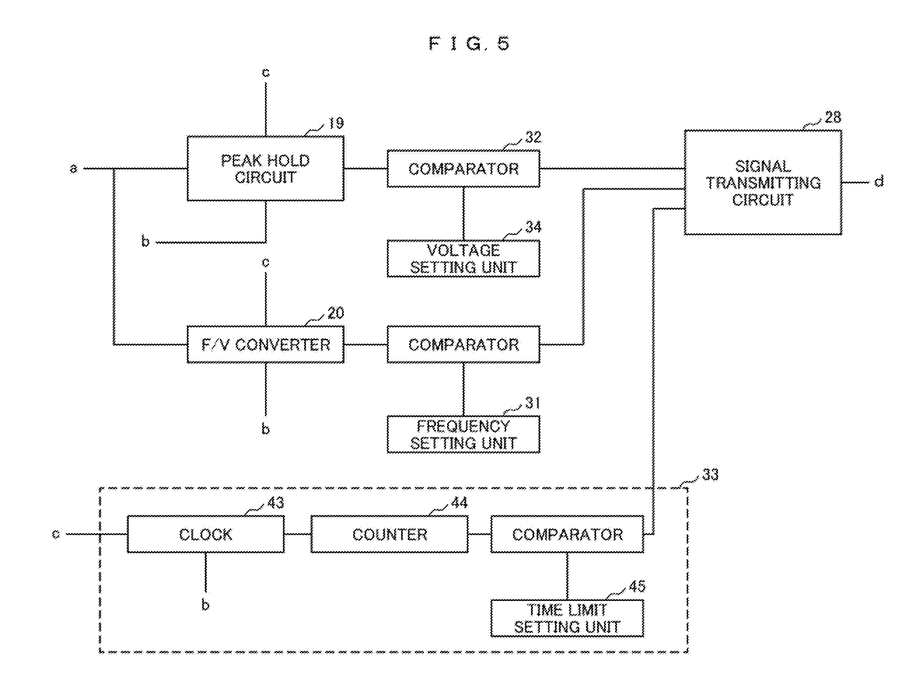

FIG. 5 illustrates a functional block diagram of the starting control circuit 30. As illustrated in FIG. 5, the starting control circuit 30 is mainly configured by: a peak hold circuit 19; a frequency/voltage converter 20 (F/V converter); a time limit setting circuit 33; and a signal transmitting circuit 28. The functions thereof are as follow.

The peak hold circuit 19 detects a peak value of an induced electromotive voltage 23 that is input (FIG. 4). In the peak hold circuit 19, the induced electromotive voltage 23 is input to a terminal a, a power source is connected to a terminal c, and the ground is connected to a terminal b that is common to the input and the power source. In the power source of the peak hold circuit 19, the AC output voltage of the AC exciter 4 (FIG. 3) is converted into a DC voltage through a diode 11b (FIG. 3) and is supplied as a constant voltage further through a resistor 18 (FIG. 3) and a zener diode 16b (FIG. 3). The voltage value of the detected induced electromotive voltage and a voltage value set by the voltage setting unit 34 are compared with each other by a comparator 32. In a case where both the voltages are the same, the comparator 32 outputs a signal to a signal transmitting circuit 28.

The F/V converter 20 is a circuit that detects a slip. The input, the output, the power source, and the ground of the F/V converter 20 are common to the peak hold circuit 19. The F/V converter 20 converts a slip into a voltage, compares the frequency of the voltage with a frequency set by a frequency setting unit 31 by using the comparator 32 and outputs a signal to the signal transmitting circuit 28 in a case where both the frequencies are the same.

From the peak hold circuit 19 side and the F/V converter 20 side, it is detected that the rotation speed is near the synchronization speed, in other words, it is timing at which switching to the synchronization operation is performed.

The peak hold circuit 19 described above may have a function capable of detecting a voltage. In addition, the F/V converter 20 may have a function capable of detecting a frequency, and, for example, in the case of a circuit having a counter function, by counting zero-crossing points, the frequency and the zero crossing points can be detected.

The signal transmitting circuit 28 delays an input signal by a delay time set by the time limit setting circuit 33 and outputs the delayed input signal from a terminal d. In other words, in the signal transmitting circuit 28, the amplitude or the frequency of the induced electromotive voltage generated in the field winding 10 is a predetermined condition for switching the connection between the AC exciter 4 and the field winding 10 to the excitation of the field winding 10. In other words, the signal transmitting circuit 28 has a function of delaying a time point at which the condition for switching to the synchronous operation is satisfied by a predetermined time. Accordingly, as will be described later, stable starting characteristics can be acquired. The time limit setting circuit 33 can arbitrarily set the delay time.

When a signal is received as an input from any one of the peak hold circuit 19 side and the F/V converter 20 side, in order to switch the operation state of the field winding type synchronous motor to the synchronization operation, the signal transmitting circuit 28 generates and outputs a control signal that is field-input by turning on the thyristor 1. Accordingly, the reliability of detection of timing at which switching to the synchronous operation is performed in improved. In addition, only one of the peak hold circuit 19 side and the F/V converter 20 side may be arranged.

The starting control circuit illustrated in FIG. 5 may be configured by any one of various circuits such as an analog circuit, a digital circuit, and an operation processing device controlled by software. In addition, such circuits may be mixed, and, for example, it may be configured such that at least the signal transmitting circuit 28 and the time limit setting circuit 33 are configured by field programmable gate arrays (FPGA), and the others are configured by analog ICs or the like. Accordingly, the delay time can be arbitrarily set in an easy manner.

Here, a detailed reason for controlling the field input based on the voltage value of the induced electromotive voltage and the frequency value of the slip, which are set in advance, is as follows. According to the load state at the time of starting, the accelerated state of the induction motor is different, and, in accordance therewith, the frequency of the slip is changed as well. By setting a proper voltage amplitude and a slip in consideration of the load state and controlling the field input based thereon, stable starting characteristics can be acquired. In other words, the voltage setting unit 34 and the frequency setting unit 31 set a proper phase condition.

As illustrated in FIG. 5, the time limit setting circuit 33 is configured by a clock 43, a counter 44, a comparator, and a time limit setting unit 45. In the time limit setting circuit 33, a circuit power supply and the ground are respectively connected to the terminals c and d. The time limit setting circuit 33 operates without using the induced electromotive voltage 23 as an input signal. At a time point at which the power is applied to the time limit setting circuit 33, the clock 43 is started, and clock signals are counted by the counter 44. The number of counts and a time that is set in advance by the time limit setting unit 45 are compared with each other by the comparator 32. When both the number of counts and the set time are the same, the comparator outputs a direction signal used for outputting a control signal to the signal transmitting circuit 28. By disposing such a time limit setting circuit 33 in the starting control circuit 30, when the power used for circuit driving is supplied to the starting control circuit 30, as will be described later, field input can he performed without detecting the induced electromotive voltage 23. In other words, the time limit setting circuit 33 has a function of connecting the AC exciter 4 to the field winding 10 when a time required for the rotation speed of the field winding type synchronous motor being the synchronization rotation speed (rated rotation speed) elapses regardless of the amplitude or the frequency of the induced electromotive voltage of the field winding 10.

The starting control circuit illustrated in FIG. 5 may be configured by any one of various circuits such as an analog circuit, a digital circuit, and an operation processing device controlled by software. In addition, such circuits may be mixed, and, for example, it may be configured such that at least the time limit setting circuit 33 is configured by a field programmable gate array (FPGA), and the others are configured by analog ICs or the like. Accordingly, the time can be arbitrarily set in an easy manner.

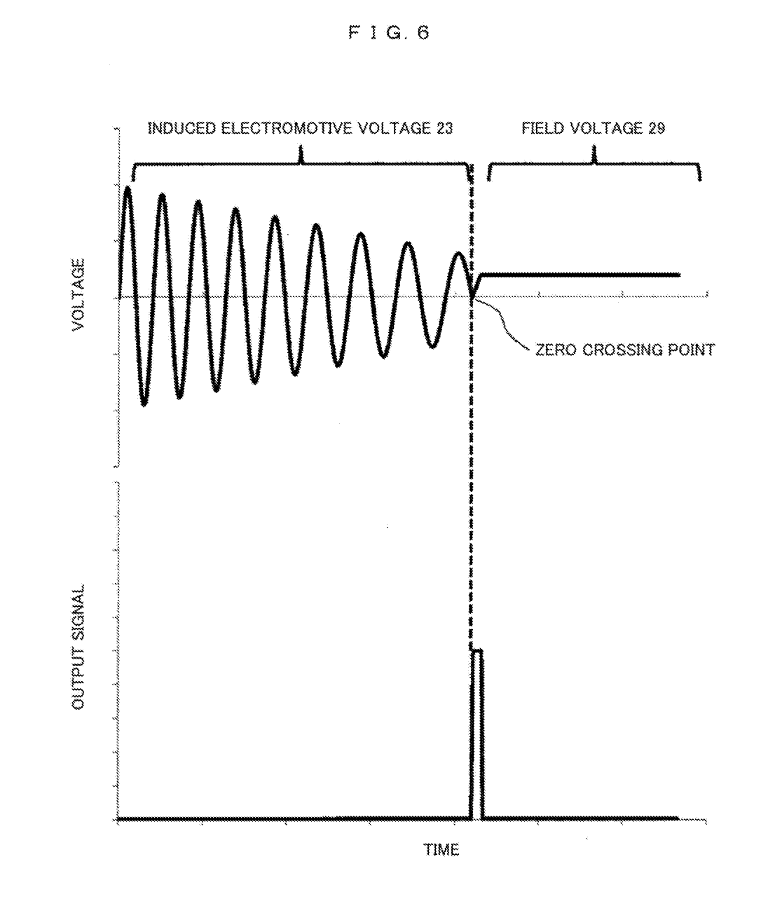

FIG. 6 illustrates an example of the waveforms of a voltage generated in the field winding and a signal output from the starting control circuit from starting to after field input in a case where the starting control circuit 30 operates based on a frequency setting. In FIG. 6, the vertical axis represents the voltage, and the horizontal axis represents the time.

As a phase to be field input, as illustrated in FIG. 6, when field input is performed to match a zero crossing point at which the induced electromotive voltage is changed to the negative polarity side, a proper phase is formed. After the field input, the voltage is changed to a field voltage 29 of the AC exciter side through a rectification circuit. Immediately after the field voltage 29 is changed to the voltage of the AC exciter side through the rectification circuit in accordance with a control signal formed by a single pulse output from the starting control circuit 30, a time constant at the time of arrival at a DC voltage is relatively small. In such a case, when field input is performed at the proper phase described above, stable starting characteristics can be acquired. In addition, the zero crossing point detecting function may be included in the peak hold circuit 19 or the F/V converter 20.

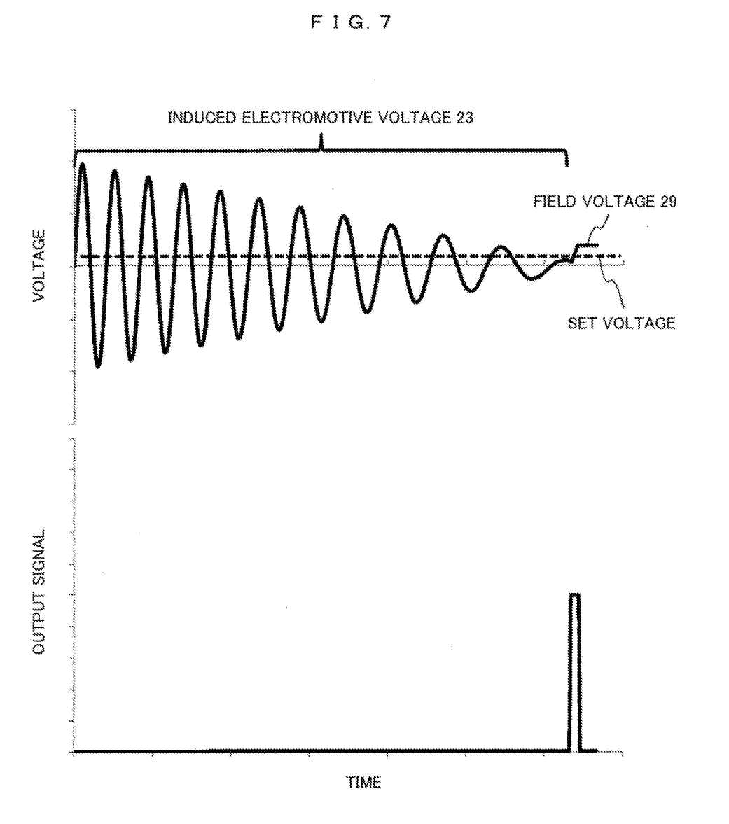

FIG. 7 illustrates an example of the waveforms of a voltage generated in the field winding and a signal output from the starting control circuit from starting to after field input in a case where the starting control circuit 30 operates based on a voltage setting. Similar to the case illustrated in FIG. 6, the vertical axis represents the voltage, and the horizontal axis represents the time.

In the case illustrated in FIG. 7, immediately after a field voltage 29 is changed according to a signal output from the starting control circuit 30, a time constant at the time of arrival at a DC voltage is larger than that of the case illustrated in FIG. 6. The magnitude of such a time constant depends on the characteristics of a motor, and it cannot be determined that a characteristic of a small time constant is acquired like a proper phase illustrated in FIG. 6. In such a case, a time point at which a condition of a proper phase to be field input is satisfied deviates from a zero crossing point at which the induced electromotive voltage 23 is changed to the negative polarity side in accordance with the influence of the time constant. Accordingly, by performing the field input at a point delayed from the zero crossing point by using the time limit setting circuit 33 (FIG. 5), stable starting characteristics can be acquired.

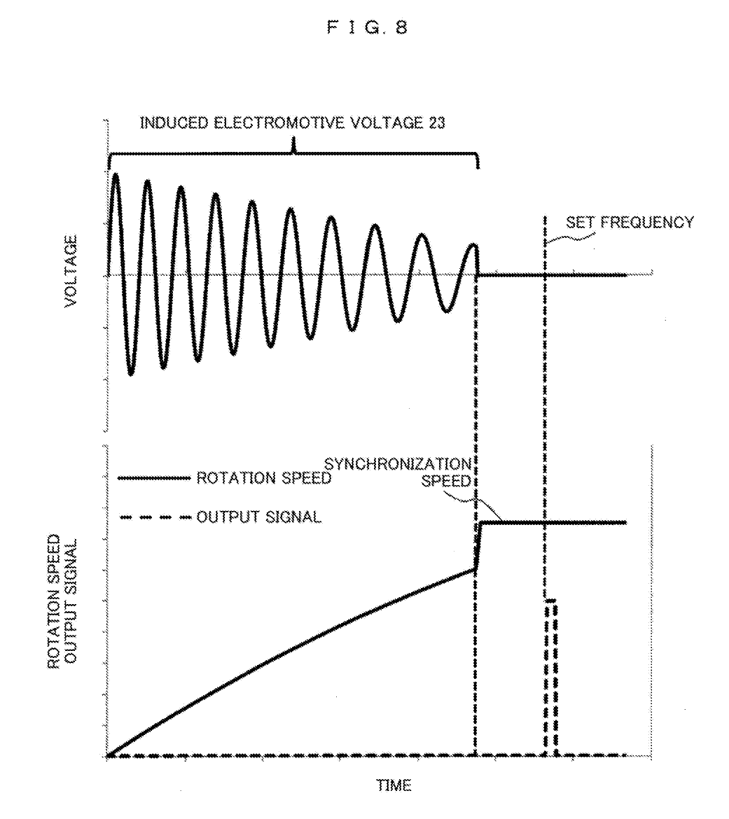

FIG. 8 illustrates an induced electromotive voltage and an output signal of the starting control circuit 30 that is delayed.

As illustrated in FIG. 8, at an arbitrary point within one period of an induced electromotive voltage from a zero crossing point, field input is performed. In addition, there are cases where a magnitude relation of inertia and the load has an influence on the condition of a proper phase. Accordingly, also in a case where stable starting characteristics cannot be acquired even when field input is performed under the condition of the proper phase set by the voltage setting unit 34 or the frequency setting unit 31, similar to this Embodiment 1, by including a function capable of arbitrarily delaying the output signal of the starting control circuit 30 that directs field input, stable starting characteristics can be acquired under various conditions.

As illustrated in FIG. 7, in the case of a voltage setting, different from the case of a frequency setting, field input is performed regardless of a voltage phase. In addition, in a case where a voltage to be set is appropriately set, for example, in a case where the voltage to be set is set to about several tens of volts when the capacity of the motor is several MW or more, field input is performed in a state in which the slip is small, and accordingly, field input can be performed regardless of a voltage phase. A conditional equation at this time is as follows.

S<(242/N)·(Pₘ/(GD²T))^{1/2}×100

Pₘ=Sₙ·(E·V/X_{d})

Here, S: slip [%], N: synchronization rotation speed [min⁻¹], GD²: bouncing effect [kg·m²], F: synchronization frequency [Hz], Sₙ: rated apparent output [kVA], E: no-load induced voltage [p·u], V: armature voltage [p·u], and X_{d}: d-axis reactance [p·u]. In a case where the slip S at the time of field input satisfies the equation described above, in other words, in a case where the right side of the inequality is less than the calculated slip, field input regardless of a voltage phase, in other words, improper phase input can be performed. On the other hand, in a case where the slip at the time of field input is more than the calculated slip, one of the rotation speed, the torque, and the stator current becomes unstable.

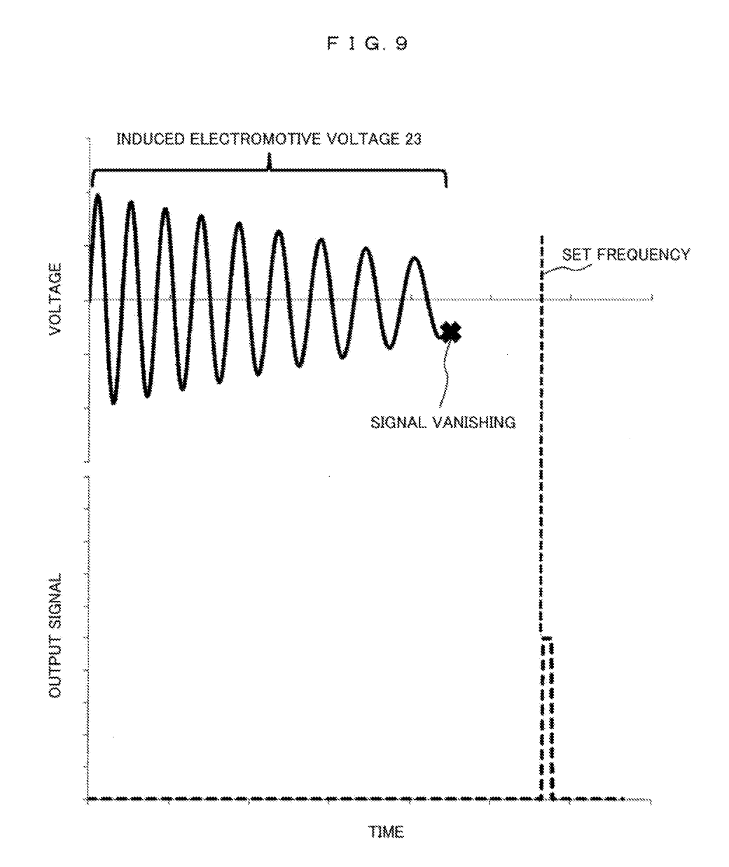

As illustrated in FIGS. 6 and 7, in a case where the induced electromotive voltage 23 can be soundly detected, the starting control circuit 30 outputs a control signal, and field input is performed. However, in a case where an abnormality occurs in the induced electromotive voltage 23, although the starting control circuit 30 is normal, the starting control circuit 30 cannot output a control signal, and field input is not performed. Such a case is illustrated in FIGS. 8 and 9.

FIG. 8 illustrates an example of the waveforms of a voltage generated in the field winding and a signal output from the starting control circuit in a case where an abnormality occurs in the induced electromotive voltage 23 detected by the starting control circuit 30. This FIG. 8 illustrates a case where the time limit setting circuit 33 (FIG. 33) is not arranged and a case of the frequency setting. Similar to the cases illustrated in FIGS. 6 and 7, the vertical axis represents the voltage, and the horizontal axis represents the time. In the drawing, the rotation speed of a motor is also illustrated. Thus, the vertical axis also represents the rotation speed.

In the case illustrated in FIG. 8, before the frequency of the induced electromotive voltage 23 becomes a set frequency, the rotation speed is rapidly increased up to the synchronization speed. In this case, as illustrated in the drawing, an output signal (control signal) (broken line) that is originally output when the frequency of the induced electromotive voltage arrives at the set frequency is not output. For this reason, the thyristor 1 (FIG. 3) cannot be turned on, and thus, field input cannot be performed.

FIG. 9 illustrates another example of the waveforms of a voltage generated in the field winding and a signal output from the starting control circuit in a case where an abnormality occurs in the induced electromotive voltage 23. This FIG. 8 is a case where the time limit setting circuit 33 (FIG. 33) is not arranged and a case of the frequency setting. Similar to the cases illustrated in FIGS. 6 and 7, the vertical axis represents the voltage, and the horizontal axis represents the time.

In the case illustrated in FIG. 9, before the frequency of the induced electromotive voltage 23 becomes a set frequency, the induced electromotive voltage 23 vanishes due to a defect or the like. Also in this case, similar to the case illustrated in FIG. 8, an output signal (control signal) (broken line) is not output. For this reason, the thyristor 1 (FIG. 3) cannot be turned on, and thus, field input cannot be performed. In addition, examples of factors of the vanishing of the induced electromotive voltage 23 include the formation of a short circuit in a detection signal path, a malfunction of the peak hold circuit or the F/V converter (for example, configured by an analog IC), and the like.

By arranging the time limit setting circuit 33 illustrated in FIG. 5, also under the situations as illustrated in FIGS. 8 and 9, the starting control circuit can output a control signal.

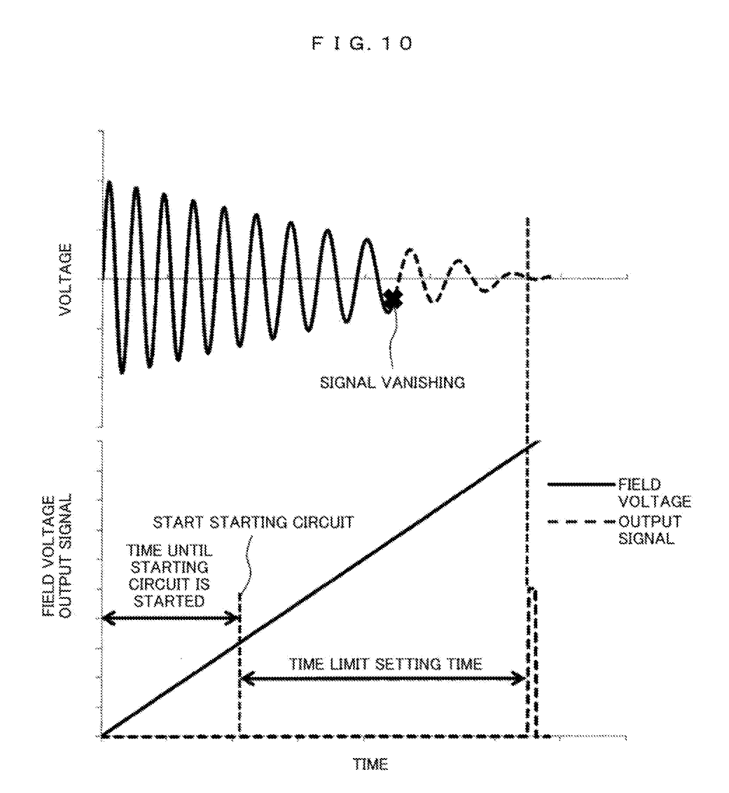

FIG. 10 illustrates an example of the waveforms of a voltage generated in the field winding and a signal output from the starting control circuit in a case where the time limit setting circuit 33 operates.

As illustrated in FIG. 10, the field voltage increases as time elapses. The starting control circuit 30 uses the field voltage as its power source. For this reason, in a case where the time is near zero, the field voltage is low, and thus, the starting control circuit 30 is not started but is started in the middle of starting. In the time limit setting unit 45 (FIG. 5), a predetermined time after the start of the starting control circuit 30 is set. The predetermined time set in the time limit setting unit is a sufficient time for the motor to be in a steady state and, as illustrated in FIG. 10, be in a state in which the slip is small. In this way, field input with an improper phase can be performed regardless of a voltage phase.

In addition, in a case where a field winding type motor is tested as a power generator while rotating another motor, this Embodiment 1 enables field input. Particularly, in a case where no-load saturation voltage is measured, the winding terminal of the stator is in an open state, and accordingly, the induced electromotive voltage 23 is not generated in the field winding 10 of the stator 5. For this reason, since a state is formed in which there is no input signal for the starting control circuit 30, field input cannot be performed. In contrast to this, according to this Embodiment 1, according to a time limit setting used for allowing a control signal to be output, also at the time of measuring a no-load saturation voltage, a signal is output from the starting control circuit 30, and field input can be performed.

As described above, according to this Embodiment 1, by arranging the time limit setting circuit, also in a case where an abnormality is present in a detected input signal such as a case where a detected input signal of the induced electromotive voltage for the starting control circuit diminishes, field input can be reliably performed. Accordingly, the reliability of field input in the field winding type synchronous motor is improved.

### Embodiment 2

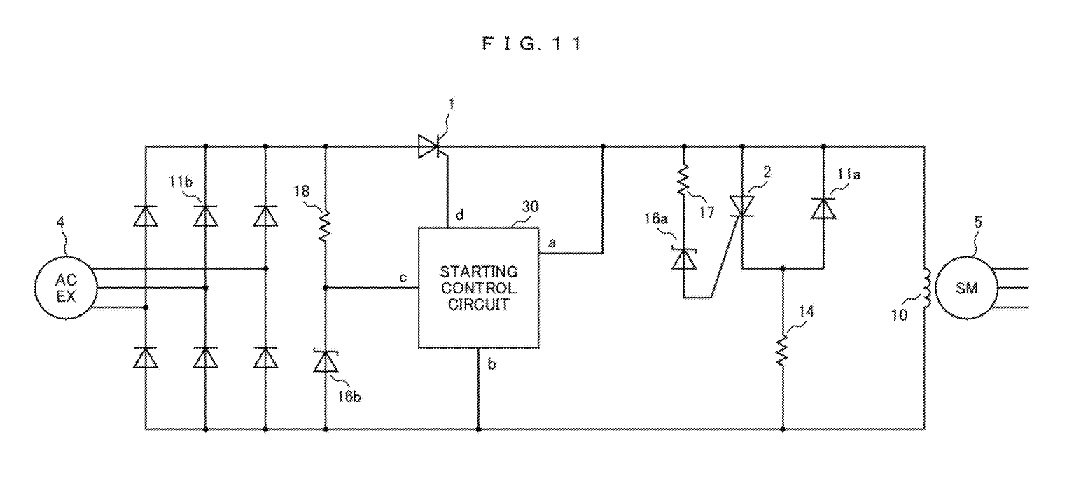

FIG. 11 illustrates the circuit configuration of a synchronous input device in a field winding type synchronous motor according to Embodiment 2 of the present invention. The external appearance and the cross-sectional views of a rotor and a stator of this Embodiment 2 are similar to those of Embodiment 1 illustrated in FIGS. 1 and 2. Hereinafter, points different from Embodiment 1 will be described.

A synchronous input device according to this Embodiment 2 includes a circuit used for electrically disconnecting the DR after field input. The DR 14, as described above, is disposed to suppress a decrease in the torque at the time of starting and causes a power loss when a current flows after the field input. For this reason, a decrease in the efficiency of the motor or heat generation is caused. Thus, in this Embodiment 2, as will be described next, the DR 14 is electrically disconnected after the field input.

In this Embodiment 2, the DR 14 is connected in parallel with a field winding 10 through a reverse parallel circuit of a thyristor 2 and a diode 11a. In other words, both ends of the field winding 10 form a short circuit according to the DR 14 through the reverse parallel circuit of the thyristor 2 and the diode 11a. Between the cathode and the gate of the thyristor 2, in order to give an induction current of the field winding 10 to the gate of the thyristor 2 as a gate signal, a series connection circuit of a zener diode 16a and the diode 11a is connected.

At the time of starting, the thyristor 1 is in the Off state, and, when a three-phase voltage is applied to a stator (FIG. 2), an induced electromotive voltage generated in the field winding 10 is applied to the zener diode 16a through a resistor 17 and the DR 14. When a reverse-direction voltage of a constant value or more is applied, according to the breakdown phenomenon of the zener diode 16a, a current flows through the gate of the thyristor 2. Accordingly, the thyristor 2 is turned on, and an induction current of the positive side flows through the DR 14. On the other hand, an induction current of the negative side flows through the DR 14 in a path including the diode 11a.

Here, the reverse-direction voltage of the constant value or more is the induced electromotive voltage 23 (FIG. 4), and, as illustrated in FIG. 4, at the time of starting, a state is formed in which the amplitude of the voltage is larger, and the frequency is high. Thus, by selecting a voltage characteristic of the zener diode 16a in accordance with the generated induced electromotive voltage 23, the thyristor 2 is turned off near a synchronization speed, and the current of the positive side flowing through the DR 14 through the thyristor 2 can be blocked. In this way, up to near the synchronization speed after starting, an induced electromotive current flows through the DR 14, and, when the speed is near the synchronization speed, only the current of the negative side of the induced electromotive current flows through the DR 14 through the diode 11a.

At the time of field input, a DC current flows through the field winding 10. Accordingly, when the thyristor 2 is turned off, the DC current is a reverse-direction current for the diode 11a, and accordingly, a current does not flow through the DR 14. Accordingly, after the field input, the DR 14 is electrically disconnected from the field winding 10. In this way, a decrease in the efficiency of the motor and heat generation can be prevented while a decrease in the torque at the time of starting is suppressed by the DR 14.

In addition, instead of the thyristor 1, an opening/closing device such as an insulated gate bipolar transistor (IGBT) or a gate turn off (GTO) thyristor may be used.

### Embodiment 3

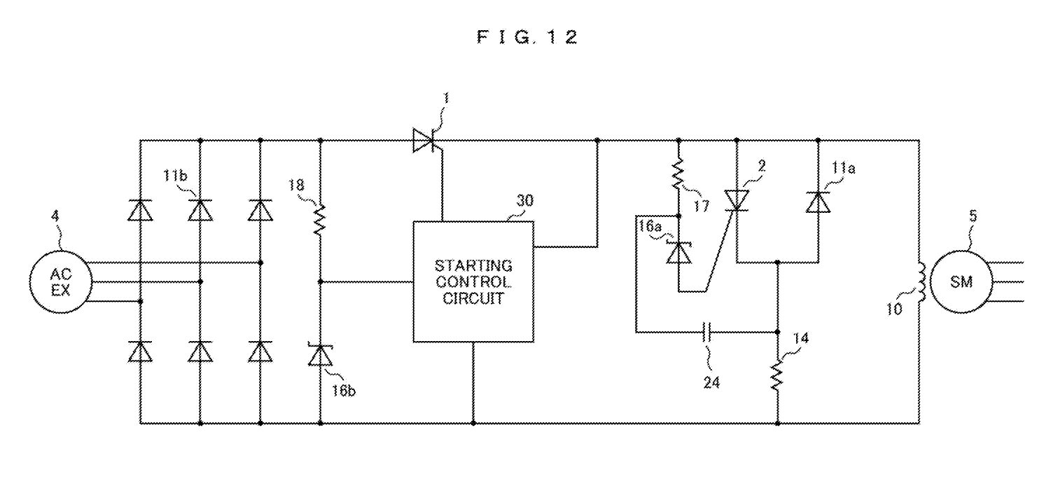

FIG. 12 illustrates the circuit configuration of a synchronous input device in a field winding type synchronous motor according to Embodiment 3 of the present invention. The external appearance and the cross-sectional views of a rotor and a stator of this Embodiment 3 are similar to those of Embodiment 1 illustrated in FIGS. 1 and 2. In addition, in the synchronous input device according to this Embodiment 3, similar to Embodiment 2 (FIG. 11), a DR 14 is connected in parallel with a field winding 10 through a reverse-parallel circuit of a thyristor 2 and a diode 11a, and, between the cathode and the gate of the thyristor 2, in order to give a gate signal to the thyristor 2, a series connection circuit of a zener diode 16a and the diode 11a is connected.

Hereinafter, points different from Embodiment 2 will be described.

In this Embodiment 3, between a connection point of a parallel connection circuit of the thyristor 2 and the diode 11a and the DR 14 and the cathode of the zener diode 16a, in other words, a connection point of a resistor 17 and the zener diode 16a, a filter capacitor 24 is connected.

As described above, as the thyristor 1 is turned on, field input is performed. When the field input is performed, a three-phase AC current supplied from an AC exciter 4 is converted into a DC current by a rectification circuit configured by six diodes 11b and is supplied to a field winding 10.

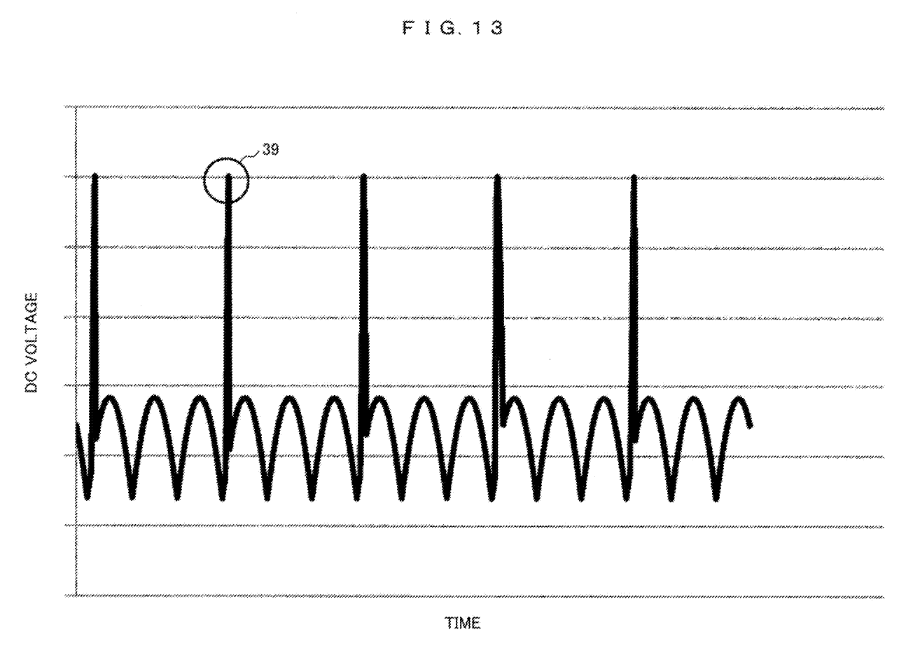

FIG. 13 illustrates the waveform of a DC voltage output by the rectification circuit.

As illustrated in FIG. 13, since the waveform of the DC voltage is a rectified three-phase electric wave, ripples are generated at a frequency that is six times the frequency of the AC exciter. As can be understood from this waveform, a surge voltage 39 is periodically generated. The magnitude of the surge voltage 39 is several times an average value of the DC voltage. The surge voltage 39 is generated according to the influence of a reverse recovery current of the diode 11b. Since an AC voltage is applied to the diode 11b, a bias voltage is applied in a reverse direction of the forward direction. The reverse recovery current is generated when the bias voltage is applied in the reverse direction and decreases according to the elapse of time. According to a decrease rate (di/dt) of a reverse-direction current at this time, the surge voltage 39 (L×(di/dt)) is generated in parasitic inductance (L) in the circuit.

The surge voltage 39 is applied also to the zener diode 16a. Thus, when the surge voltage 39 becomes excessive, the zener diode 16a breaks down, and the thyristor 2 is turned on, and there is a possibility that the disconnected DR 14 is connected to the field winding 10 again. In contrast to this, in this Embodiment 3, the filter capacitor 24 as described above functions as a low pass filter, and accordingly, re-turning on of the thyristor 2 in accordance with the surge voltage 39 can be prevented.

The frequency component of the surge voltage 39 has a frequency further higher than that of the DC ripple (a component of a frequency that is six times the frequency), and accordingly, it is preferable to appropriate set the capacitance of the capacitor in accordance with the frequency of the AC exciter. In addition, also for an abrupt change in the voltage according to a noise or the like, the filter capacitor 24 functions as a low pass filter (generally, a noise has a high frequency), and accordingly, the thyristor 2 is maintained in the Off state, and the DR 14 can be reliably disconnected from the field winding 10. As the filter capacitor 24, it is preferable to use a film capacitor that has a relatively low influence of a change due to aging. In addition, according to this Embodiment 3, only the filter capacitor 24 is added, and accordingly, an increase in the number of components is suppressed while the function for presenting the re-turning on of the thyristor 2 according to the surge voltage 39 is added.

### Embodiment 4

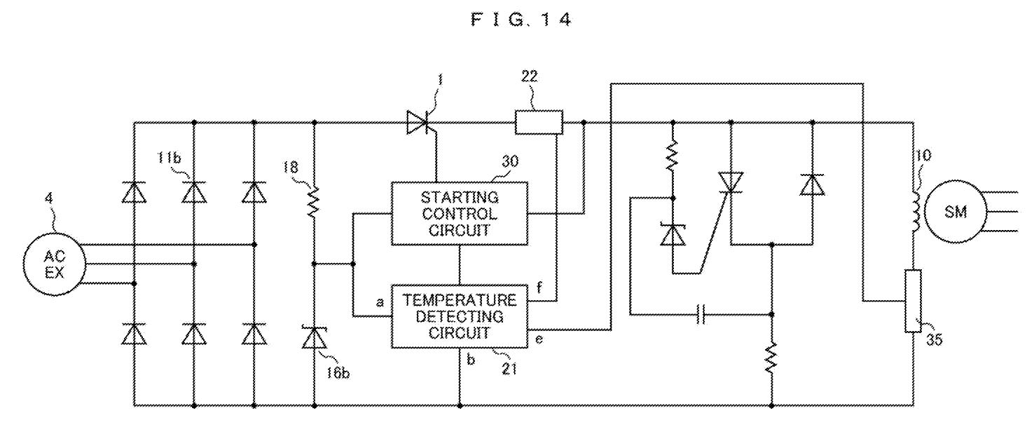

FIG. 14 illustrates the circuit configuration of a synchronous input device in a field winding type synchronous motor according to Embodiment 4 of the present invention. The external appearance and the cross-sectional views of a rotor and a stator of this Embodiment 4 are similar to those of Embodiment 1 illustrated in FIGS. 1 and 2. In the synchronous input device according to this Embodiment 3, similar to Embodiment 2 (FIG. 11), a DR 14 is connected in parallel with a field winding 10 through a reverse parallel circuit of a thyristor 2 and a diode 11a, and, between the cathode and the gate of the thyristor 2, in order to give a gate signal to the thyristor 2, a series connection circuit of a zener diode 16a and the diode 11a is connected. In addition, similar to Embodiment 3 (FIG. 12), between a connection point of a parallel connection circuit of the thyristor 2 and the diode 11a and the DR 14 and the cathode of the zener diode 16a, in other words, a connection point of a resistor 17 and the zener diode 16a, a filter capacitor 24 is connected.

Hereinafter, points different from Embodiment 3 will be described.

As illustrated in FIG. 14, in this Embodiment 4, a temperature sensor 35 is attached to the field winding 10, and the temperature of the field winding 10 is detected. A signal supplied from the temperature sensor 35 is input to a temperature detecting circuit 21. In a case where the temperature is a temperature set in advance or higher, an opening/closing device 22 arranged between the thyristor 1 and the field winding 10 is turned off.

In the temperature detecting circuit 21, a signal supplied from the temperature sensor 35 is input to a terminal e, a power source is connected to a terminal a, and the ground is connected to a terminal b that is common to the input and the power source. The temperature detecting circuit 21 generates a control signal of the opening/closing device 22 based on the signal supplied from the temperature sensor 35 and outputs the generated control signal to a terminal f. When this control signal is given to a control terminal of the opening/closing device, the opening/closing device 22 is turned on or turned off in accordance with the control signal. As the opening/closing device 22, a self arc-extinguishing device that can be turned on or off, for example, an IGBT or the like is applied.

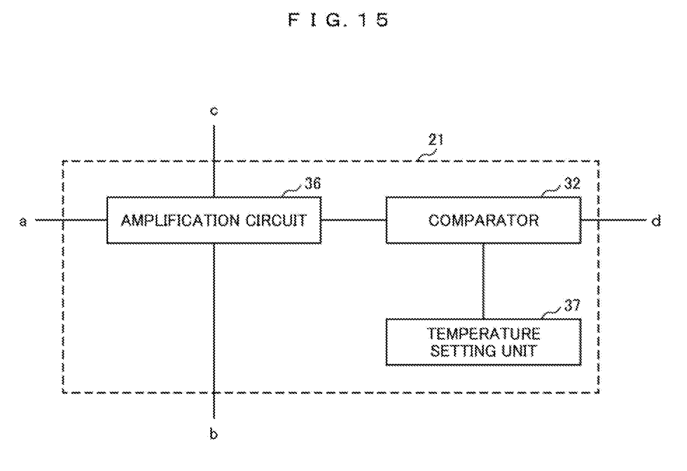

FIG. 15 illustrates the internal configuration of the temperature detecting circuit 21.

As illustrated in FIG. 15, a signal, which is supplied from the temperature sensor 35, input to the terminal a is amplified by an amplification circuit 36. As a drive power source of the amplification circuit 36, an AC output voltage of an AC exciter 4 (FIG. 14) is converted into a DC voltage through the diode 11b (FIG. 14) and is further supplied as a constant voltage through a constant voltage circuit configured by a resistor 18 (FIG. 14) and a zener diode 16b (FIG. 14). A comparator 32 compares the voltage of a signal amplified by the amplification circuit 36 and a voltage set in advance in the temperature setting unit 37 with each other and outputs a control signal toward the opening/closing device 22 to the terminal d in a case where both are the same.

According to this Embodiment 4, in a case where the temperature of the field winding 10 becomes a temperature upper limit value allowed for the field winding, the opening/closing device 22 is turned off, and the state is returned to the DOL state from the synchronous operation state. Returned to the DOL state, and, in a case where the slip is low, the induced electromotive current is lower than a field current, and accordingly, over-heating of the field winding 10 can be avoided. On the other hand, returning to the DOL state, and, in a case where the slip is high, the rotation speed is decreased as well, and accordingly, it can be detected that the motor is in an abnormal state.

### Embodiment 5

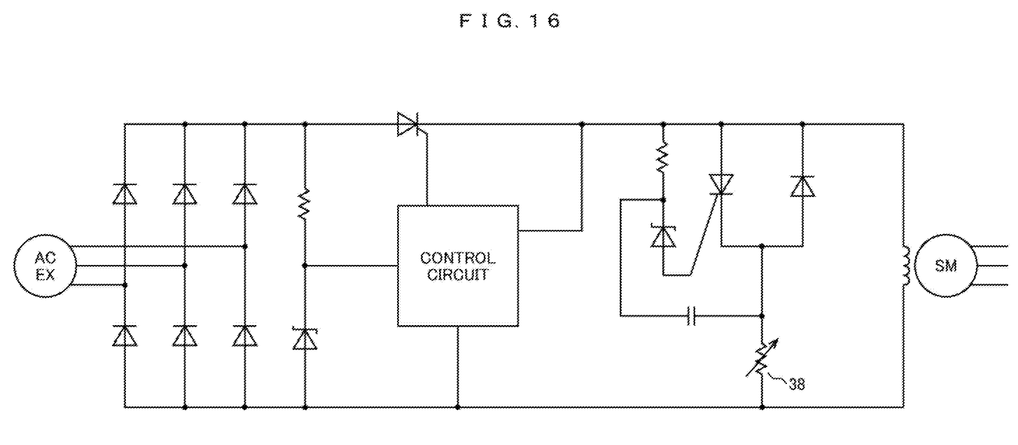

FIG. 16 illustrates the circuit configuration of a synchronous input device in a field winding type synchronous motor according to Embodiment 5 of the present invention. The external appearance and the cross-sectional views of a rotor and a stator of this Embodiment 5 are similar to those of Embodiment 1 illustrated in FIGS. 1 and 2.

While the circuit configuration of the synchronous input device according to Embodiment 5 is almost the same as that according to Embodiment 3 (FIG. 12), different from Embodiment 3, a discharge resistance DR (the DR 14 illustrated in FIG. 12) is configured by a variable resistor 38. By configuring the DR to be the variable resistor 38, also in a case where the characteristics (the output and the frequency) of the motor are changed, an optimal resistance value can be set. By optimizing the resistance value of the DR, a starting current can be minimized.

### Embodiment 6

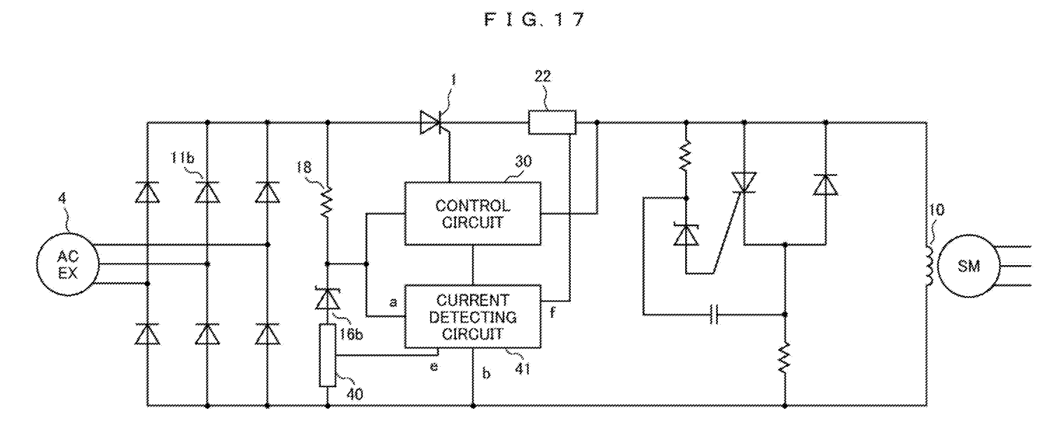

FIG. 17 illustrates the circuit configuration of a synchronous input device in a field winding type synchronous motor according to Embodiment 6 of the present invention. The external appearance and the cross-sectional views of a rotor and a stator of this Embodiment 6 are similar to those of Embodiment 1 illustrated in FIGS. 1 and 2.

While the circuit configuration of the synchronous input device according to this Embodiment 6 is almost the same as that according to Embodiment 4 (FIG. 14), hereinafter, points different from those according to Embodiment 4 will be described.

As illustrated in FIG. 17, between the anode side of a zener diode 16b, a current sensor 40 that detects a current flowing through the zener diode 16b is arranged.

A signal transmitted from the current sensor 40 is input to a current detecting circuit 41, and the current detecting circuit 41, in a case where a detected current represented by the signal is a current set in advance or higher, turns off an opening/closing device 22 disposed between a thyristor 1 and a field winding 10.

In the current detecting circuit 41, a signal transmitted from the current sensor 40 is input to a terminal e, a power source is connected to a terminal a, and the ground is connected to a terminal b that is common to the input power supply. The current detecting circuit 41 generates a control signal of the opening/closing device 22 based on the signal transmitted from the current sensor 40 and outputs the generated control signal to a terminal f. When this control signal is given to a control terminal of the opening/closing device, the opening/closing device 22 is turned on or turned off in accordance with the control signal. As the opening/closing device 22, a self arc-extinguishing device that can be turned on or off, for example, an IGBT or the like is applied.

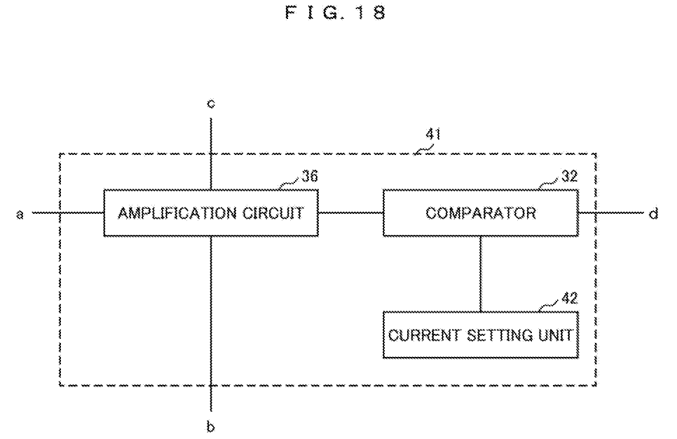

FIG. 18 illustrates the internal configuration of the current detecting circuit 41.

As illustrated in FIG. 18, a signal, which is supplied from the current sensor 40, input to the terminal a is amplified by an amplification circuit 36. As a drive power source of the amplification circuit 36, an AC output voltage of an AC exciter 4 (FIG. 17) is converted into a DC voltage through the diode 11b (FIG. 17) and is further supplied as a constant voltage through a constant voltage circuit configured by a resistor 18 (FIG. 17) and a zener diode 16b (FIG. 17). A comparator 32 compares the voltage of a signal amplified by the amplification circuit 36 and a voltage set in advance in the temperature setting unit 42 with each other and outputs a control signal toward the opening/closing device 22 to the terminal d in a case where both are the same.

According to this Embodiment 6, in a case where a current transmitted from the AC exciter is in an excessive current state, the opening/closing device 22 is turned off, and the state is returned to the DOL state from the synchronous operation state. Returning to the DOL state, in a case where the slip is low, an induced electromotive current is lower than the field current, and accordingly, the overheating of the field winding 10 can be avoided. On the other hand, returning to the DOL state, in a case where the slip is high, the rotation speed is decreased, and accordingly, it can be detected that the motor is in an abnormal state. In addition, since a current of the anode side of the zener diode 16b is detected, the current is lower than the field current, and accordingly, the current sensor 40 can be configured to have a small volume and to be compact.

In addition, a current detection position in the circuit is not limited to the detection position according to this embodiment but may be a position at which a current flowing through the field winding or a current transmitted from the AC exciter can be detected directly or indirectly.

### Embodiment 7

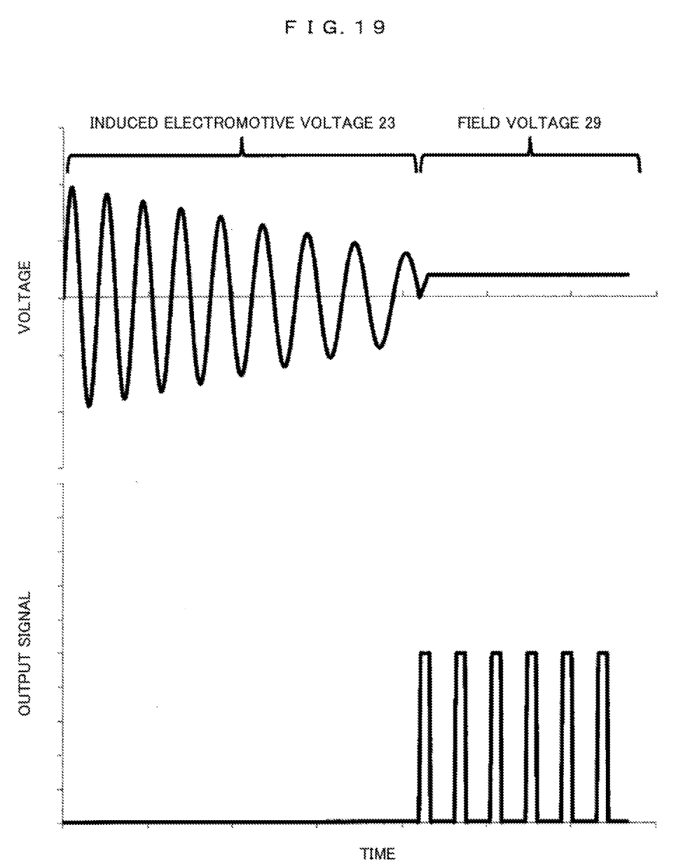

FIG. 19 illustrates an example of the waveforms of a voltage generated in a field winding and a signal output from a starting control circuit from starting until after field input in a field winding type synchronous motor according to Embodiment 7 of the present invention. In FIG. 19, while the vertical axis represents the voltage, and the horizontal axis represents the time. While FIG. 19 illustrates a case where a time limit setting circuit 33 (FIG. 5) is not operated, a case where the time limit setting circuit is operated is similar thereto.

In this Embodiment 7, the waveform of a signal output from the starting control circuit is different from that according to Embodiment 1 as below.

As illustrated in FIG. 19, in this Embodiment 7, after the condition of field input is satisfied, signals are intermittently output from the starting control circuit.

At the time of switching to a DC voltage supplied from the AC exciter in accordance with the field input, in a case where the slip is large or the like, there are cases where the voltage is highly disturbed. At this time, in a case where the amplitude of the disturbed voltage swings up to the negative polarity side, there is a high possibility that the thyristor 1 is turned off. As above, when the thyristor 1 is turned off, in a case where an output signal transmitted from the starting control circuit 30 is only one pulse, it is difficult to perform field input again. In other words, the field input is not performed, but the motor continuously operates as an induction motor. In contrast to this, in this Embodiment 7, pulse signals are continuously output intermittently after the condition of field input is satisfied, in other words, a pulse train configured by a plurality of continuous pulses is output, whereby field input can be performed again.

### Embodiment 8

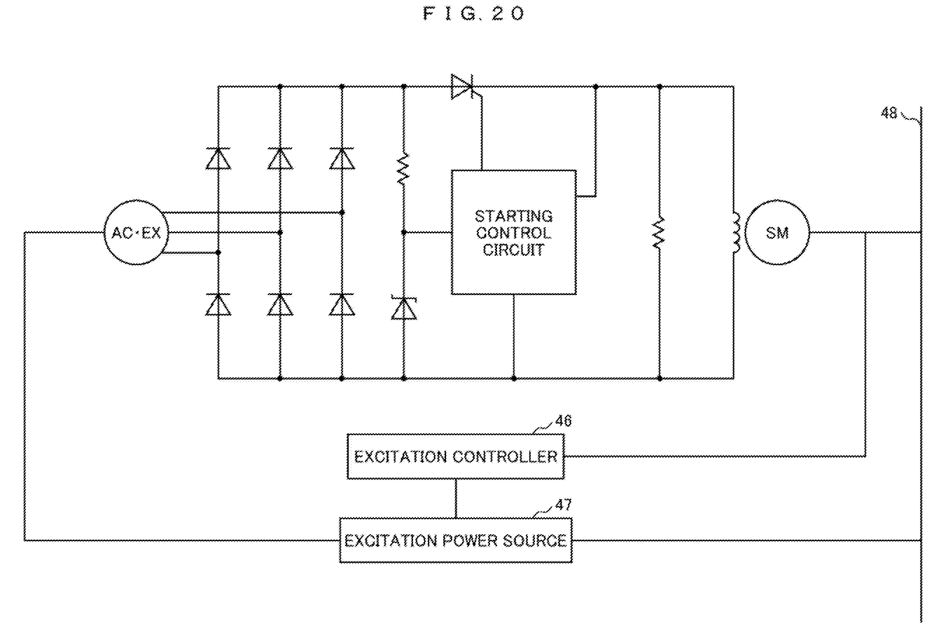

FIG. 20 illustrates the circuit configuration of a field winding type synchronous motor according to Embodiment 8 of the present invention.

In this Embodiment 8, an excitation power source 47 and an excitation controller 46 are connected to a field winding type synchronous motor according to Embodiment 1.

As illustrated in FIG. 20, an AC exciter (AC·EX) is excited by the excitation power source 47. Before starting, a thyristor used for field input is in the Off state, and the conduction of the field winding is blocked, and accordingly, the field winding is excited by applying the excitation power source 47 in a stop state. When a control signal is transmitted from a starting control circuit, and field input is performed, a control signal is transmitted from the excitation controller 46 to the excitation power source 47, and an excitation current is controlled. The excitation controller 46 is connected between a stator and a system 48.

After the field input is performed, when the field winding type synchronous motor according to this Embodiment 8 is in a synchronized state, the excitation controller 46 calculates a voltage and a current of the stator and, in a case where the power factor is not 1.0, performs control of the excitation current to cause the power factor to be 1.0. For this reason, the excitation controller 46 is controlled with the synchronized state checked. In a case where control start of the excitation controller 46 is set using a time, the time is set to a time that is longer than a sum of a time until the starting of a starting circuit and a time set as a time limit. Alternatively, after checking that the speed arrives at the synchronization speed by using a speed sensor or the like, the control of the excitation controller 46 is started. In this way, it can be prevented that the excitation current is controlled before the formation of a synchronized state, and stable starting characteristics are acquired.

### Embodiment 9

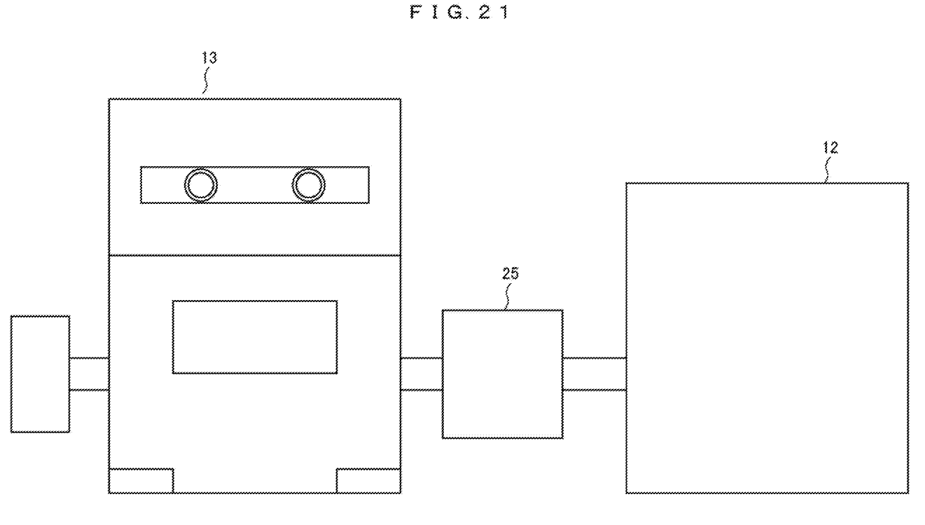

FIG. 21 is an external view of a field winding type synchronous motor according to Embodiment 9 of the present invention.

In this Embodiment 9, a shaft that is a rotation shaft of the field winding type synchronous motor 13 is connected to a compressor 12 through a speed increasing gear 25. As the field winding type synchronous motor 13, any one of Embodiments 1 to 8 is applied.

According to this Embodiment 9, the field winding type synchronous motor can be installed in a plant requiring a compressor such as a plant for producing LNG or medicines or a chemical plant and be operated.

The present invention is not limited to the embodiments described above, but various modifications are included therein. For example, while the embodiments described above have been described in detail for easy understanding of the present invention, and thus, the present invention is not necessarily limited to an embodiment including all the described configurations. In addition, for a part of the configuration of each embodiment, addition, removal, or substitution of another configuration may be performed.

1. A field winding type synchronous motor that, after starting by forming a short circuit of a field winding, excites the field winding by using an exciter, the field winding type synchronous motor comprising:
the exciter; and
a starting control circuit that outputs a control signal controlling On/Off of a first opening/closing device, the exciter and the field winding are connected through the first opening/closing device,
wherein the starting control circuit includes:
a signal transmitting circuit that outputs the control signal at timing, which is detected based on an induced electromotive voltage generated in the field winding, at which switching to a synchronous operation is performed; and
a time limit setting circuit that, after a predetermined time elapses after the starting control circuit is started, directs the signal transmitting circuit to output the control signal.

2. The field winding type synchronous motor according to claim 1, wherein the starting control circuit detects the timing based on an amplitude or a frequency of the induced electromotive voltage.

3. The field winding type synchronous motor according to claim 1, wherein the time limit setting circuit includes a time limit setting unit capable of arbitrarily setting the predetermined time.

4. The field winding type synchronous motor according to claim 3, wherein the time limit setting circuit counts a time after the start of the starting control circuit and, in a case where the counted time is equal to the predetermined time set by the time limit setting unit, directs the signal transmitting circuit to output the control signal.

5. The field winding type synchronous motor according to claim 1, wherein the predetermined time is a time until a rotation speed becomes a synchronization speed after the start of the starting control circuit.

6. The field winding type synchronous motor according to claim 1, wherein the field winding forms a short circuit in accordance with a discharge resistor connected between both ends of the field winding.

7. The field winding type synchronous motor according to claim 6, wherein the discharge resistor is connected between both the ends of the field winding through a second opening/closing device.

8. The field winding type synchronous motor according to claim 7, wherein the second opening/closing device is a thyristor and is turned on by giving an induced electromotive current supplied from the field winding to a gate through a series connection circuit of a resistor and a zener diode.

9. The field winding type synchronous motor according to claim 1, further comprising:
a third opening/closing device that is connected between the first opening/closing device and the field winding; and
a temperature detecting circuit that controls On/Off of the third opening/closing device based on a temperature of the field winding,
wherein the temperature detecting circuit turns off the third opening/closing device in a case where the temperature of the field winding is a temperature set in advance or higher.

10. The field winding type synchronous motor according to claim 6, wherein the discharge resistor is a variable resistor.

11. The field winding type synchronous motor according to claim 1, further comprising:
a third opening/closing device that is connected between the first opening/closing device and the field winding; and
a current detecting circuit that controls On/Off of the third opening/closing device based on a current supplied from the exciter to the field winding,
wherein the current detecting circuit turns off the third opening/closing device in a case where the current is a current set in advance or higher.

12. The field winding type synchronous motor according to claim 1, wherein the control signal is configured by a pulse train that is formed by a plurality of continuous pulse signals.

13. The field winding type synchronous motor according to claim 1, further comprising:
an excitation power source that excites the exciter; and
an excitation controller that controls the excitation power source in accordance with the control signal.

14. The field winding type synchronous motor according to claim 1, wherein a shaft that is a rotation shaft is mechanically connected to a compressor through a speed increasing gear.

15. A method of controlling a field winding type synchronous motor that includes an exciter and, after starting by forming a short circuit of a field winding, excites the field winding by using the exciter, the method comprising:
connecting the exciter to the field winding when a time required for a rotation speed being a synchronization speed elapses regardless of an amplitude or a frequency of an induced electromotive voltage of the field winding.
